(19) United States
(12) Patent Application Publication
(10) Pub. No.: US 2017/0374714 A1
(43) Pub. Date: Dec. 28, 2017

(54) LINEAR CONTROL DEVICE, SYSTEM AND METHOD FOR COLOR RENDERING OF RGB LEDS

(71) Applicant: Matthew Murphy, Mukwonago, WI (US)

(72) Inventor: Matthew Murphy, Mukwonago, WI (US)

(21) Appl. No.: 15/628,117

(22) Filed: Jun. 20, 2017

Related U.S. Application Data
(60) Provisional application No. 62/352,231, filed on Jun. 20, 2016.

(51) Int. Cl. H05B 33/08; G09G 3/34

(52) U.S. Cl. CPC H05B 33/0845; H05B 33/086; G09G 3/3413; H05B 33/0857

(57) ABSTRACT

Linear control of RGB LED for generating ambient lighting with variable color is accomplished by using multiple linear regulators to vary LED intensity via analog dimming. Each regulator controls current through a given color LED which in turn varies the LED intensity. Given the wavelength shift of LEDs at various drive currents and perceived intensity difference to the human eye, for different colors, the current regulator response may be non-linear and unique depending upon the desired color. Further, the linear drive current regulation can be accomplished using voltage mode or current mode control. The device, system and methodology, each using RGB LEDs, can reproduce any color on the Cartesian Color Coordinate system.

This application claims the benefit of U.S. Provisional Application No. 62/352,231 filed Jun. 20, 2016.

### FIELD OF THE INVENTION

The present invention relates generally to electrical devices and systems of the type that can be electrically energized and used without generating significant amounts of electrical “noise” or electromagnetic interference (“EMI”), also called radio frequency interference (“RFI”) when the noise generated is within the radio frequency spectrum. The present invention also relates general to electrical devices and systems that include light emitting diode (“LED”) light sources, wherein the LED typically comprises a two-lead semiconductor light source that functions via electroluminescence and the light color and brightness of the LED is determined by the energy band gap of the semiconductor. More particularly, the invention relates to an LED lighting device or system that uses an alternative to conventional pulse width modulation (“PWM”) to change the light color and brightness of the LED lighting device, or an array of such devices when used in a system.

### BACKGROUND OF THE INVENTION

EMI is typically generated by digital signals. This includes pulse width modulation (“PWM”), which emits “noise” that can adversely affect other electronic equipment operating in the vicinity. RFI noise is particularly troublesome when is emitting in a magnetic resonance imaging (“MRI”) scan room. One single digital signal, with sharp edges and high current, can “spray” harmonics of the fundamental frequency and emit a full spectrum of RF, both conducted and radiated. This spectrum, ranging from low kilohertz (“kHz”) to gigahertz (“GHz”) will generate artifacts in the MRI scan image, which is highly undesirable. The white pixel artifacts that are generated can seriously impair the quality of the imaging results.

In the case of red-green-blue (“RGB”) LED lighting control for color reproduction in an MRI scan room, PWM control is more straight forward and easier to implement, but it definitely suffers from EMI as stated above. Accordingly, it is desirable to avoid generating artifacts within such imaging rooms, including those generated by RGB LED lighting controls.

### SUMMARY OF THE INVENTION

The solution to this EMI problem is “linear control” where the load driver current is not digital, does not have sharp edges, and the only frequency present is the sinewave ripple. However, designers prefer digital over linear control because linear requires larger physical size, is less efficient and more heatsinking is required. PWM is the preferred method for changing color in RGB LED applications. PWM allows or consistent LED wavelength, or color, because the LED is operating at the manufacturer's specified drive current.

Linear current control of LED lighting, or any load for that matter, is not a new idea. In fact linear, or analog, control of loads was the original control method prior to digital. It will differ from present technology because the feedback used to generate the control signal will have to be non-linear and compensate for anomalies and characteristics associated with driving LEDs at current levels not typically specified by the LED manufacturer. The unusual feature is using analog drive current to create various colors, with RGB LEDs, necessitated by the need for exceptionally low EMI emissions. The advantage to linear drive current is the ability to operate multicolored lights in an MRI environment with no emissions. That is, such lighting must be electronically “quiet” in an MRI scan room, for example.

Linear control of RGB LED for generating ambient lighting with variable color is accomplished by using multiple linear regulators to vary LED intensity via analog dimming. Each regulator controls current through a given color LED which in turn varies the LED intensity. Given the wavelength shift of LEDs at various drive currents and perceived intensity difference to the human eye, for different colors, the current regulator response may be non-linear and unique depending upon the desired color. Further, the linear drive current regulation can be accomplished using voltage mode or current mode control. Voltage mode control offers the advantage of being “load independent” but less accurate. Current mode control has the advantage of accuracy at the expense of more complex feedback. The system, using RGB LEDs, can reproduce any color on the Cartesian Color Coordinate system. Control can be implemented using only one set of RGB LEDs, hundreds, or even thousands.

The foregoing and other features of the device, system and method of the present invention will be apparent from the following detailed description when read in conjunction with the accompanying drawing.

### BRIEF DESCRIPTION OF THE DRAWINGS

FIG. 1 is a schematic drawing of a circuit configured to function in accordance with the device, system and method of the present invention.

FIG. 2 is a graph illustrating the linear to non-linear color algorithm input as compared to the output values.

### DETAILED DESCRIPTION

As discussed above, linear control of RGB LED for generating ambient lighting with variable color is accomplished by using multiple linear regulators to vary LED intensity via analog dimming. Each regulator controls current through a given color LED which in turn varies the LED intensity. Given the wavelength shift of LEDs at various drive currents and perceived intensity difference to the human eye, for different colors, the current regulator response may be non-linear and unique depending upon the LED color being controlled. Further, the control can be accomplished using voltage mode or current mode control. Voltage mode control offers the advantage of being “load independent” but less accurate. Current mode control has the advantage of accuracy at the expense of more complex feedback. The system, using RGB LEDs, can reproduce any color on the Cartesian Color Coordinate system.

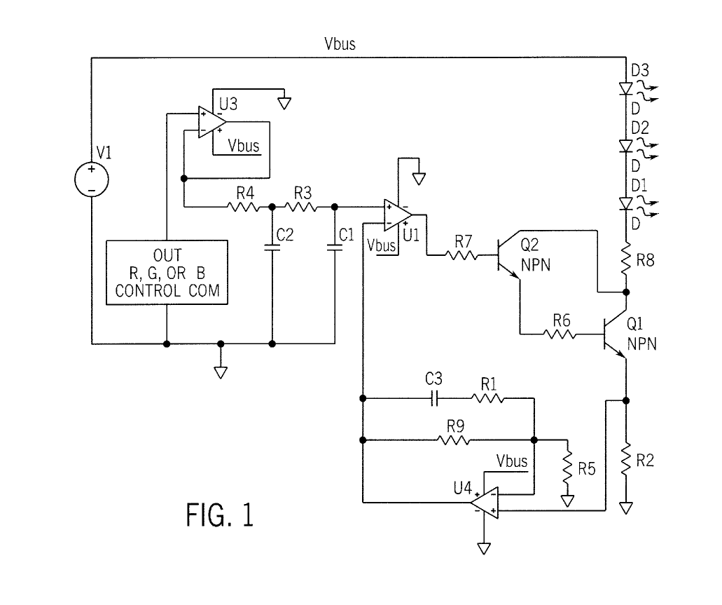

FIG. 1 shows one embodiment of an analog regulator circuit for a colored LED array that is configured in accordance with the present invention. This circuit operates with a 14V DC bus and a series parallel LED array (not shown, but which would be in parallel with the LEDs D1, D2 and D3). This embodiment does not show signal control processed via a microprocessor or a description of the response shape (TBD). V1 is a simulating PWM control source which gets filtered by R3, R4, C1, and C2. This is for simulation purposes only and was a quick way to size and validate the power structure.

On the actual embodiment, the control signal, applied to U3's non-inverting terminal, will be generated by a microprocessor. The signal will be programmed to fit the unique non-linear curve required for the exact color intensity needed to reproduce the desired “CIELUV” coordinate location (CIE 1976 (L*, u*, v*) color space, or CIELUV, is a two dimensional color space adopted by the International Commission on Illumination and is used extensively used for applications that deal with colored lights).

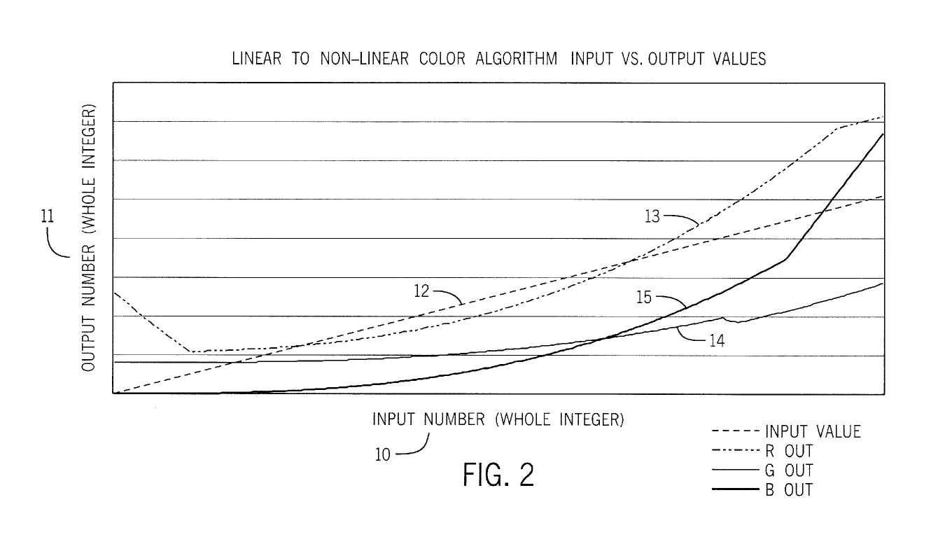

Referring now to FIG. 2, it shows the requested intensity value 10 in the x-axis as compared to the scaled value 11 in the y-axis that is required to compensate for the color shift given a linear drive current for R, G and B output. The lines on the chart show true linear 12, scaled R output 13, scaled G output 14 and scaled B output 15. The algorithm used will change based on temperature, LED manufacturer, LED package, etc.

In summary, linear current control of an LED, or any load for that matter, is not a new idea. In fact linear, or analog, control of loads was the original control method prior to digital. The present invention differs from present technology because the feedback used to generate the control signal will have to be non-linear and compensate for anomalies and characteristics associated with driving LED at current levels not specified by the LED manufacturer. The unusual feature is using analog drive current to create various colors, with RGB LED, necessitated by the need for exceptionally low EMI emissions. The advantage to this is the ability to operate multicolored lights in an MRI environment with no emissions.

Possible applications include analog dimming of white lights in the MRI scan room; the addition of wavelength shifted phosphor coated white LEDs to increase the color rendering index and correlated color temperature of white light generated with RGB for task lighting.

I claim:

1. A linear control device for color rendering of an RGB LED comprising:
an RGB LED that emits light; and
multiple linear regulators to vary intensity of the light emitted by the RGB LED via analog dimming;
wherein each linear regulator controls current through the RGB LED to enable varying the light intensity of the RGB LED such that the color of light emitted is controlled.

2. The linear control device of claim 1 wherein the linear drive current regulation is accomplished using a voltage mode control.

3. The linear control device of claim 1 wherein the linear drive current regulation is accomplished using a current mode control.

4. The linear control device of claim 1 further comprising a microprocessor that generates a control signal wherein the signal is pre-programmed to fit a unique non-linear curve required for the color intensity needed to reproduce a desired CIELUV coordinate location for the RGB LED.

5. A linear control system for color rendering of a plurality of RGB LEDs comprising:
a plurality of RGB LEDs, each RGB LED being functionally adapted to emit light; and
multiple linear regulators to vary intensity of the light emitted by the plurality of RGB LEDs via analog dimming;
wherein each linear regulator controls current through the plurality of RGB LEDs to enable varying the light intensity of the RGB LEDs such that the color of light emitted is controlled.

6. The linear control system of claim 5 wherein the linear drive current regulation is accomplished using a voltage mode control.

7. The linear control system of claim 5 wherein the linear drive current regulation is accomplished using a current mode control.

8. The linear control system of claim 5 further comprising a microprocessor that generates a control signal wherein the signal is pre-programmed to fit a unique non-linear curve required for the color intensity needed to reproduce a desired CIELUV coordinate location for the plurality of RGB LEDs.

9. A method for color rendering of a plurality of RGB LEDs via linear control comprising the steps of:
providing a plurality of RGB LEDs, each RGB LED being functionally adapted to emit light; and
providing multiple linear regulators to vary intensity of the light emitted by the plurality of RGB LEDs via analog dimming;
wherein each linear regulator controls current through the plurality of RGB LEDs to enable varying the light intensity of the RGB LEDs such that the color of light emitted is controlled.

10. The linear control method of claim 9 wherein the linear drive current regulation step is accomplished using a voltage mode control.

11. The linear control method of claim 9 wherein the linear drive current regulation step is accomplished using a current mode control.

12. The linear control method of claim 9 further comprising the step of providing a microprocessor that generates a control signal wherein the signal is pre-programmed to fit a unique non-linear curve required for the color intensity needed to reproduce a desired CIELUV coordinate location for the plurality of RGB LEDs.
